(19) United States
(12) Patent Application Publication
(10) Pub. No.: US 2014/0078024 A1
(43) Pub. Date: Mar. 20, 2014

(54) PROTECTION OF ELECTRO-OPTIC DISPLAYS AGAINST THERMAL EFFECTS

(71) Applicants: Richard J. Paolini, JR., Framingham, MA (US); Libing Zhang, Sharon, MA (US)

(72) Inventors: Richard J. Paolini, JR., Framingham, MA (US); Libing Zhang, Sharon, MA (US)

(73) Assignee: E INK CORPORATION, Cambridge, MA (US)

(21) Appl. No.: 12/940,381

(22) Filed: Nov. 5, 2010

Related U.S. Application Data
(62) Division of application No. 10/604,630, filed on Aug. 6, 2003, now abandoned.
(60) Provisional application No. 60/319,450, filed on Aug. 6, 2002.

(51) Int. Cl. G09G 3/20; B29C 65/54

(52) U.S. Cl. 345/55; 156/146

(57) ABSTRACT

An electro-optic display comprises a layer of reflective electro-optic material capable of changing its optical state on application of an electric field, an electrode, a heat generating component in heat conducting relationship with the electro-optic material, and a heat shield disposed between the heat generating component and the electro-optic material, the heat shield comprising a layer of thermally insulating material and a layer of thermally conducting material, the thermally conducting material being disposed between the thermally insulating material and the electro-optic material. The invention also provides an electrophoretic medium comprising a suspending fluid and a plurality of electrically charged particles suspended in the suspending fluid and capable of moving therethrough upon application of an electrical field to the electrophoretic medium, the suspending fluid containing a compatibilizer to reduce its coefficient of thermal expansion.

### REFERENCE TO RELATED APPLICATIONS

This application is a division of copending application Ser. No. 10/604,630, filed Aug. 6, 2003 (Publication No. 2004/0105036), which itself claims priority from Provisional Application Ser. No. 60/319,450 filed Aug. 6, 2002. The entire disclosure of this provisional application, and of all U.S. patents and applications mentioned below, are herein incorporated by reference.

### BACKGROUND OF INVENTION

This invention relates to protection of electro-optic displays against thermal effects. More specifically, this invention relates to methods for reducing the thermal expansion coefficients of the suspending fluid used in electrophoretic media, and to methods for shielding electro-optic media against heat generated in electronic components located adjacent the media.

Electro-optic displays comprise a layer of electro-optic material, a term which is used herein in its conventional meaning in the art to refer to a material having first and second display states differing in at least one optical property, the material being changed from its first to its second display state by application of an electric field to the material. The optical property is typically color perceptible to the human eye, but may be another optical property, such as optical transmission, reflectance, luminescence or, in the case of displays intended for machine reading, pseudo-color in the sense of a change in reflectance of electromagnetic wavelengths outside the visible range.

One type of electro-optic display is a rotating bichromal member type as described, for example, in U.S. Pat. Nos. 5,808,783; 5,777,782; 5,760,761; 6,054,071 6,055,091; 6,097,531; 6,128,124; 6,137,467; and 6,147,791 (although this type of display is often referred to as a “rotating bichromal ball” display, the term “rotating bichromal member” is preferred as more accurate since in some of the patents mentioned above the rotating members are not spherical). Such a display uses a large number of small bodies (typically spherical or cylindrical) which have two or more sections with differing optical characteristics, and an internal dipole. These bodies are suspended within liquid-filled vacuoles within a matrix, the vacuoles being filled with liquid so that the bodies are free to rotate. The appearance of the display is changed to applying an electric field thereto, thus rotating the bodies to various positions and varying which of the sections of the bodies is seen through a viewing surface.

Another type of electro-optic medium is an electrochromic medium, for example an electrochromic medium in the form of a nanochromic film comprising an electrode formed at least in part from a semi-conducting metal oxide and a plurality of dye molecules capable of reversible color change attached to the electrode; see, for example O'Regan, B., et al., Nature 1991, 353, 737; and Wood, D., Information Display, 18(3), 24 (March 2002). See also Bach, U., et al., Adv. Mater., 2002, 14(11), 845. Nanochromic films of this type are also described, for example, in U.S. Pat. No. 6,301,038, International Application Publication No. WO 01/27690, and in copending application Ser. No. 10/249,128, filed Mar. 18, 2003.

Another type of electro-optic display, which has been the subject of intense research and development for a number of years, is the particle-based electrophoretic display, in which a plurality of charged particles move through a suspending fluid under the influence of an electric field. Electrophoretic displays can have attributes of good brightness and contrast, wide viewing angles, state bistability, and low power consumption when compared with liquid crystal displays. Nevertheless, problems with the long-term image quality of these displays have prevented their widespread usage. For example, particles that make up electrophoretic displays tend to settle, resulting in inadequate service-life for these displays.

Numerous patents and applications assigned to or in the names of the Massachusetts Institute of Technology (MIT) and E Ink Corporation have recently been published describing encapsulated electrophoretic media. Such encapsulated media comprise numerous small capsules, each of which itself comprises an internal phase containing electrophoretically-mobile particles suspended in a liquid suspension medium, and a capsule wall surrounding the internal phase. Typically, the capsules are themselves held within a polymeric binder to form a coherent layer positioned between two electrodes. Encapsulated media of this type are described, for example, in U.S. Pat. Nos. 5,930,026; 5,961,804; 6,017,584; 6,067,185; 6,118,426; 6,120,588; 6,120,839; 6,124,851; 6,130,773; 6,130,774; 6,172,798; 6,177,921; 6,232,950; 6,249,721; 6,252,564; 6,262,706; 6,262,833; 6,300,932; 6,312,304; 6,312,971; 6,323,989; 6,327,072; 6,376,828; 6,377,387; 6,392,785; 6,392,786; 6,413,790; 6,422,687; 6,445,374; 6,445,489; 6,459,418; 6,473,072; 6,480,182; 6,498,114; 6,504,524; 6,506,438; 6,512,354; 6,515,649; 6,518,949; 6,521,489; 6,531,997; 6,535,197; 6,538,801; 6,545,291; and 6,580,545; and U.S. Patent Applications Publication Nos. 2002/0019081; 2002/0021270; 2002/0053900; 2002/0060321; 2002/0063661; 2002/0063677; 2002/0090980; 2002/0106847; 2002/0113770; 2002/0130832; 2002/0131147; 2002/0145792; 2002/0171910; 2002/0180687; 2002/0180688; 2002/0185378; 2003/0011560; 2003/0011867; 2003/0011868; 2003/0020844; 2003/0025855; 2003/0034949; 2003/0038755; 2003/0053189; 2003/0076573; 2003/0096113 and 2003/0102858; and International Applications Publication Nos. WO 99/67678; WO 00/05704; WO 00/20922; WO 00/38000; WO 00/38001; WO 00/36560; WO 00/67110; WO 00/67327; WO 01/07961; and WO 01/08241.

Many of the aforementioned patents and applications recognize that the walls surrounding the discrete microcapsules in an encapsulated electrophoretic medium could be replaced by a continuous phase, thus producing a so-called polymer-dispersed electrophoretic display in which the electrophoretic medium comprises a plurality of discrete droplets of an electrophoretic fluid and a continuous phase of a polymeric material, and that the discrete droplets of electrophoretic fluid within such a polymer-dispersed electrophoretic display may be regarded as capsules or microcapsules even though no discrete capsule membrane is associated with each individual droplet; see for example, the aforementioned 2002/0131147. Accordingly, for purposes of the present application, such polymer-dispersed electrophoretic media are regarded as sub-species of encapsulated electrophoretic media.

An encapsulated electrophoretic display typically does not suffer from the clustering and settling failure mode of traditional electrophoretic devices and provides further advantages, such as the ability to print or coat the display on a wide variety of flexible and rigid substrates. (Use of the word “printing” is intended to include all forms of printing and coating, including, but without limitation: pre-metered coatings such as patch die coating, slot or extrusion coating, slide or cascade coating, curtain coating; roll coating such as knife over roll coating, forward and reverse roll coating; gravure coating; dip coating; spray coating; meniscus coating; spin coating; brush coating; air knife coating; silk screen printing processes; electrostatic printing processes; thermal printing processes; ink jet printing processes; and other similar techniques.) Thus, the resulting display can be flexible. Further, because the display medium can be printed (using a variety of methods), the display itself can be made inexpensively.

A related type of electrophoretic display is a so-called “microcell electrophoretic display”. In a microcell electrophoretic display, the charged particles and the suspending fluid are not encapsulated within microcapsules but instead are retained within a plurality of cavities formed within a carrier medium, typically a polymeric film. See, for example, International Application Publication No. WO 02/01281, and published US Application No. 2002-0075556, both assigned to Sipix Imaging, Inc.

The optical characteristics of most electro-optic media vary significantly with temperature. For example, the electrical resistivity of an encapsulated electrophoretic medium varies inversely with temperature, decreasing as the temperature increases. This variation of electrical resistivity with temperature affects how much current passes through the medium when it is driven with a constant drive pulse, and this is turn affects the rate at which the medium switches. Encapsulated electrophoretic media are typically capable of achieving gray scale, and in such gray scale media, thermal variation of the switching rate can have the serious side effect of distorting gray scale. For example, consider a medium capable of 16 gray levels. An impulse which would switch a pixel of the medium from gray level 0 (black) to gray level 8 (a middle shade of gray) when applied at 20° C. might switch the pixel from gray level 0 to gray level 10 (a substantial lighter shade of gray than level 8) when applied at 40° C. Such changes in gray levels are readily perceived by the human eye.

Similar problems are encountered with other types of electro-optic media. For example, the switching characteristics of rotating bichromal member media will vary with temperature due to changes with temperature in the viscosity of the liquid medium which surrounds the rotating bichromal members, and such temperature-dependent changes may affect the gray scale of the medium.

The problems caused by temperature changes in electro-optic media are exacerbated if the temperature of the display becomes non-uniform, since the switching characteristics, and the gray scale “drift” discussed above, will then vary from point to point within the display. The human eye is much more sensitive to gray scale variations within a display than to a uniform drift in gray scale of the whole display.

Unfortunately, it is often necessary or desirable to mount electro-optic media in close proximity to heat generating components. Electro-optic displays often require substantial amounts of electrical circuitry. For example, high resolution electro-optic displays typically use an active matrix drive scheme in which the electro-optic medium is sandwiched between two sets of electrodes, namely a common transparent front plane electrode which covers the face of the display seen by an observer, and a matrix of pixel electrodes “behind” the electro-optic medium. Each of the pixel electrodes defines one pixel of the display and is associated with a non-linear element (typically a thin film transistor). The non-linear elements, in combination with row and column electrodes, control the voltages applied to the pixel electrodes, and thus the image produced on the display. Such an active matrix display requires numerous row and column drivers, and other circuitry, to control the operation of the large number of non-linear elements, for example 480,000 in an 800×600 display. In portable apparatus, it is necessary to keep the display as compact as possible, and to this end, if the electro-optic medium is of a reflective type (i.e., if the electro-optic medium forms an image by reflection of incident light, rather than by transmission of light through the electro-optic medium) the electronic circuitry is usually mounted behind the visible portion of the display, thus essentially keeping the size of the display to that of the display area itself, plus a small surround. “Rear mounting” the electronic circuitry behind the visible display in this manner does not have any adverse effect on the displayed image, since reflective electro-optic media, such as the rotating bichromal member, electrochromic, and particle-based electrophoretic media already described, are essentially opaque and hence hide the electronic circuitry from an observer viewing the display. (Such rear mounting of electronic circuitry is of course not possible in displays using transmissive electro-optic media, such as conventional liquid crystals, since the electronic circuitry would be visible as shadows or dark areas on the display.) However, rear mounting the electronic circuitry leads to heat flow from heat generating components (such as logic chips and perhaps batteries) to the electro-optic medium, thus causing non-uniform heating of the medium, with the aforementioned deleterious effects on image quality.

In one aspect, the present invention seeks to provide means for reducing or eliminating non-uniform heating of an electro-optic medium caused by heat generating components disposed adjacent the medium.

There is another thermal problem encountered in encapsulated and microcell electrophoretic displays, namely that the thermal expansion of the suspending fluid within the capsules or microcells exceeds that the walls surrounding the capsules or microcells, thus causing mechanical strains within the electrophoretic medium. In many cases, the maximum temperature which an encapsulated or microcell electrophoretic medium can tolerate is limited by these mechanical strains, which at high temperatures can become so great that the capsules or microcells rupture, permitting the internal phase comprising the electrophoretic particles and suspending fluid to escape and rendering the affected portions of the medium non-functional.

This capsule/microcell bursting problem can be experienced while the display is in use, but tends to be a greater problem during manufacture of displays. The manufacture of an electro-optic display normally involves at least one lamination operation. For example, in several of the aforementioned MIT and E Ink patents and applications, there is described a process for manufacturing an encapsulated electrophoretic display in which an encapsulated electrophoretic medium comprising capsules in a binder is coated on to a flexible substrate comprising indium-tin-oxide or a similar conductive coating (which acts as an one electrode of the final display) on a plastic film, the capsules/binder coating being dried to form a coherent layer of the electrophoretic medium firmly adhered to the substrate. Separately, a backplane, containing an array of pixel electrodes and an appropriate arrangement of conductors to connect the pixel electrodes to drive circuitry, is prepared. To form the final display, the substrate having the capsule/binder layer thereon is laminated to the backplane using a lamination adhesive. (A very similar process can be used to prepare an electrophoretic display useable with a stylus or similar movable electrode by replacing the backplane with a simple protective layer, such as a plastic film, over which the stylus or other movable electrode can slide.) In one preferred form of such a process, the backplane is itself flexible and is prepared by printing the pixel electrodes and conductors on a plastic film or other flexible substrate. Depending upon the exact components used in the display, the lamination may have to be conducted under heat and/or pressure, and this heat and/or pressure may cause the aforementioned capsule/microcell bursting problem.

This bursting problem is exacerbated by the types of suspending fluids used in many electrophoretic media. Such suspending fluids may comprise a mixture of an aliphatic hydrocarbon and a halocarbon. Although there does not appear to be any discussion in the literature on this point, the present inventors have found that such aliphatic hydrocarbon/halocarbon mixtures are highly non-ideal liquids, which have substantially larger coefficients of thermal expansion than would be expected for liquids which are almost ideal.

In a second aspect, the present invention provides an electrophoretic medium in which the suspending fluid has a reduced coefficient of thermal expansion, thus rendering the medium less susceptible to damage at elevated temperatures.

### SUMMARY OF INVENTION

Accordingly, in one aspect this invention provides an electro-optic display comprising:
a layer of electro-optic material capable of changing its optical state on application of an electric field thereto;
at least one electrode arranged to apply an electric field to the layer of electro-optic material;
a heat generating component in heat conducting relationship with the layer of electro-optic material; and
a heat shield disposed between the heat generating component and the layer of electro-optic material, the heat shield comprising a layer of thermally insulating material and a layer of thermally conducting material, the layer of thermally conducting material being disposed between the layer of thermally insulating material and the layer of electro-optic material.

As discussed in more detail below, in one preferred form of this electro-optic display, the heat shield comprises a printed circuit board having a conductive layer therein. The heat shield may comprise a plurality of layers of thermally insulating material and a plurality of layers of thermally conducting material, the layers of thermally insulating material alternating with the layers of thermally conducting material, and one layer of thermally conducting material being disposed between the layers of thermally insulating material and the layer of electro-optic material. Also, in the electro-optic display of the present invention, it is desirable that the layer of thermally insulating material and the layer of thermally conducting material extend across the whole area of the layer of electro-optic material. The heat shield may comprise a polymeric film having a metal layer formed thereon; for example, the heat shield may have the form of an aluminized film.

In some cases, the structure of the heat generating component may itself provide the layer of thermally insulating material; for example, the heat generating component could be a battery back having a polymeric casing which can serve as the layer of thermally insulating material. In such cases, the present invention can be practiced simply by providing a layer of thermally conducting material between the heat generating component and the layer of electro-optic material.

The heat shield of the present invention may be used with any type of reflective electro-optic material. Thus, for example, the electro-optic medium may be a rotating bichromal member material or an electrochromic material. Alternatively, the electro-optic material may be an electrophoretic material. For example, the electrophoretic material may be of the encapsulated type and comprise at least one capsule having a capsule wall encapsulating a suspending fluid and a plurality of electrically charged particles suspended in the suspending fluid and capable of moving therethrough on application of an electric field to the electrophoretic material. Alternatively, the electrophoretic material may be of the microcell type and comprise a substrate having a plurality of closed cells formed therein, each of the cells having therein a suspending fluid and a plurality of electrically charged particles suspended in the suspending fluid and capable of moving therethrough on application of an electric field to the electrophoretic material.

In another aspect, this invention provides an electrophoretic medium comprising a suspending fluid and a plurality of electrically charged particles suspended in the suspending fluid and capable of moving therethrough upon application of an electrical field to the electrophoretic medium. The suspending fluid contains a compatibilizer to reduce its coefficient of thermal expansion. In one embodiment of this invention, the electrophoretic medium is either encapsulated or of the microcell type. In another embodiment of this invention, the suspending fluid comprises a mixture of an aliphatic hydrocarbon and a chlorinated hydrocarbon, and the compatibilizer comprises a fluorocarbon.

### BRIEF DESCRIPTION OF THE DRAWINGS

FIG. 1 of the accompanying drawings is a schematic side elevation of a preferred embodiment of an electro-optic display of the present invention which makes use of multilayer printed circuit boards to provide a heat shield.

FIG. 2 is a graph showing the variation of density with temperature for an electrophoretic display suspending fluid with and without a compatibilizer.

FIG. 3 is a graph showing the average change in density with temperature for various suspending fluids similar to that used to produce the data shown in FIG. 2 but with varying proportions of suspending fluid components.

### DETAILED DESCRIPTION

As already indicated, the present invention relates to two discrete methods for protection of electro-optic displays against thermal effects. These two methods can be used alone or in combination, but for convenience will hereinafter be described separately.

Provision of Heat Shield

As already mentioned, in one aspect this invention provides an electro-optic display having a heat shield disposed between a heat generating component and a layer of electro-optic material, this heat shield comprising a layer of thermally insulating material and a layer of thermally conducting material disposed between the layer of thermally insulating material and the layer of electro-optic material.

The heat generating component of the present electro-optic display may be of any known type. The component may be, for example an alternating current/direct current conversion component, such as a transformer, or another type of power supply or battery; all batteries generate some heat because of their internal resistance. The component may also be a resistor, inductor, microprocessor, or a memory component. Obviously, multiple heat generating components may be present; for example, a display intended to operate from either an internal battery or mains will typically include a transformer, a battery and a microprocessor as heat generating components.

Although one cannot eliminate heat generation in an electro-optic display in which it is necessary to mount heat generating electrical components adjacent the electro-optic medium, one can minimize the extent that the heat generated by such components distorts the image displayed on the medium. As already indicated, distortions arising from local concentrations of heat generation that cause the temperature of the electro-optic medium to vary between adjacent regions of the display tend to be more troublesome than variations caused by uniform temperature changes, because the human eye is more sensitive to variations in image quality between different regions of a display than to variations which are uniform across the entire display. By incorporating a heat shield of the present invention, one “homogenizes” the temperature variations within the display due to non-uniform distribution of heat-generating electronic components and the display medium experiences a more uniform temperature, thus largely eliminating image variations within the display due to such non-uniform temperatures. The heat shield is especially effective in removing sharp gradients in temperature which are particularly noticeable to the eye. The heat shield of the present invention also serves to reduce the overall amount of heat reaching the display medium and thus further reduces thermal distortions of the image displayed.

As is well known to those skilled in the technology of heat shields, such shields are often constructed solely from insulating material; for example, many types of simple thermal insulators rely upon a porous medium to achieve low thermal conductivity, but these types of insulators tend to be bulky and are thus unsuitable for use in small, portable electronic devices in which electro-optic displays are often used. Use of such an “insulator only” heat shield in an electro-optic display does reduce the total amount of heat reaching the electro-optic medium from heat-generating electronic components, but allows substantial temperature differences to persist between different areas of the display. By using a heat shield of the present invention comprising both an insulating layer and a thermally conductive layer, one can achieve a much more homogeneous temperature distribution within the display, and consequently a much more uniform image.

The heat shield used in the present invention can be a discrete, purpose built component of the display provided solely for its heat shielding function. However, since for reasons of cost it is obviously desirable to minimize the number of discrete components needed in such a display, it is generally preferred to provide the thermally insulating and conductive layers of the heat shield using materials which also serve other functions. In particular, a preferred embodiment of the invention takes advantage of the properties of circuit boards which are typically present in electro-optic displays for mounting of the electronic components of such displays. Such circuit boards are often constructed using a fiberglass/epoxy composite material to give stiffness, and this fiberglass/epoxy composite material is a thermal insulator. However, most modern circuit boards use a multilayer circuit design, and such designs typically include ground or constant voltage planes to minimize electrical noise. These ground planes are usually formed from copper or gold plate, both of which are excellent thermal conductors. Thus, if a multilayer circuit board having a insulating layer such as a fiberglass/epoxy composite and a ground plane formed from a thermally conductive metal is arranged within an electro-optic display so as to lie parallel to the layer of electro-optic material, with its ground plane facing this material, such a multilayer circuit board can serve as a heat shield of the present invention.

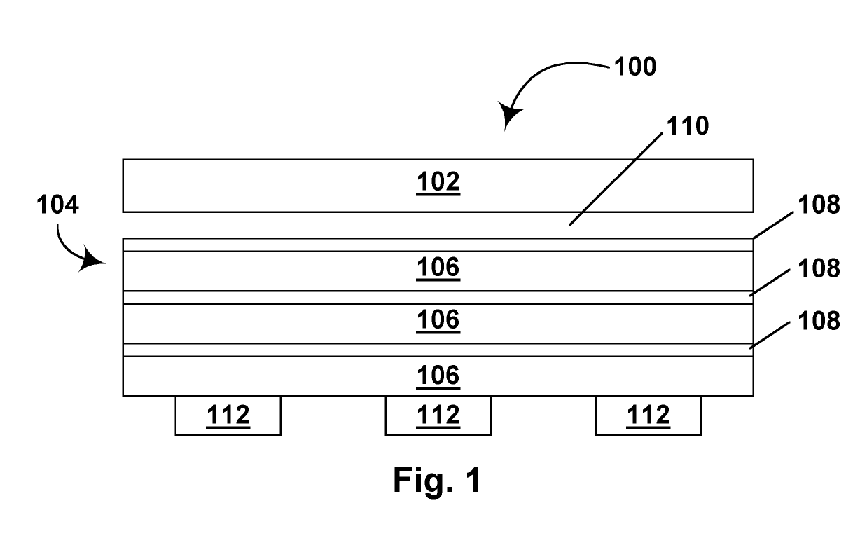

FIG. 1 is a schematic side elevation of a preferred embodiment of the present invention which makes use of multilayer circuit boards in this manner. FIG. 1 shows a display (generally designated 100) having a layer of electro-optic material 102; this layer 102 is sandwiched between two sets of electrodes, which are omitted from FIG. 1 for ease of comprehension. The display 100 further comprises three circuit boards 104, each of which has a fiberglass/epoxy composite layer 106 and a ground plane 108, each board 104 being arranged so that its ground plane 108 is on the side facing the layer of electro-optic material 102. The board 104 closest to the layer 102 is separated therefrom by an air gap 110; this air gap can if desired by replaced by an insulating layer. Heat generating components 112 are arranged on the opposed side of the circuit boards 104 from the electro-optic layer 102.

The alternating insulating and conductive layers provided by the circuit boards 104 shown in FIG. 1 are highly effective in maintaining a constant temperature across the whole area of the electro-optic layer 102 despite the localized heat generation by the heat generating components 112.

As indicated in FIG. 1, the circuit boards 104 extend across the whole area of the electro-optic layer 102. While the extent of the circuit boards 104 may not be required to house the necessary electronics, it is undesirable to terminate the circuit boards 104 short of the boundaries of the electro-optic layer 102, since to do so risks causing significant thermal gradients at the boundaries of the circuit boards 104, and consequent highly visible variations in the image displayed.

In cases where it is not convenient to use printed circuit boards as the heat shield, several alternative types of material may be employed. In particular, polymeric films coated with thin layers of metal are suitable for use as heat shields. Such materials are available commercially, for example the material known as “aluminized Mylar” (“MYLAR” is a registered trade mark) from E.I. du Pont de Nemours & Company, Wilmington, Del.; this material comprises a thin layer of aluminum on a polyethylene terephthalate base. Metallized films have the advantage of flexibility, so that they can be fitted around non-planar components when necessary. Multiple thicknesses of metallized films can be used to produce a structure similar to that shown in FIG. 1, with multiple alternating insulating and conductive layers.

As already indicated, the electro-optic display of the present invention may make use of any of the aforementioned types of reflective electro-optic material. Apart from the provision of the heat shield in accordance with the present invention, the preferred materials and structures for the electro-optic material are unchanged, and for further details the reader is referred to the various patents and applications mentioned above.

Provision of Compatibilizer in Suspending Fluid

As already indicated, this invention also provides an electrophoretic medium in which the suspending fluid contains a compatibilizer to reduce its coefficient of thermal expansion. The electrophoretic medium may be encapsulated or of the microcell type. In a preferred form of the invention, the suspending fluid comprises a mixture of an aliphatic hydrocarbon and a chlorinated hydrocarbon, and the compatibilizer comprises a fluorocarbon.

As already discussed, the ability of encapsulated and microcell electrophoretic media to withstand elevated temperatures without damage is limited by the thermal expansion of the suspending fluid used in the medium, and the coefficient of thermal expansion of the suspending fluid is typically substantially higher than the walls and/or binder with which the suspending fluid is surrounded.

The suspending fluid used in any electrophoretic medium needs to fulfil a variety of different criteria, as discussed in detail in the aforementioned MIT and E Ink patents and applications. These criteria include density, refractive index, dielectric constant, specific gravity, boiling point and long-term chemical compatibility with both the electrophoretic particles (for example, the suspending fluid must not cause the charge on the electrophoretic particles to leak away over time) and the wall surrounding the suspending fluid. The number of criteria which must be satisfied by the suspending fluid greatly restricts the materials which can be used in practical electrophoretic media, and many of the aforementioned MIT and E Ink patents and applications recommend the use of an aliphatic hydrocarbon mixed with approximately an equal weight of a chlorinated hydrocarbon. Because of all the other criteria which a suspending fluid has to meet, it appears from the literature that little thought has previously been given to the thermal properties of such an aliphatic hydrocarbon/halocarbon blend, and indeed many workers in the field may have assumed that such blends would closely approach ideal mixtures, with the thermal properties of the blends being substantially equal to the weighted average of that of the components.

It has now been found this is not in fact the case, and that aliphatic hydrocarbon/halocarbon blends are highly non-ideal liquids, and more specifically that the coefficient of thermal expansion of some blends differs very substantially from the weighted averages of the components. In particular, within the range of 40-60 percent w/w, mixtures of Isopar G (an aliphatic hydrocarbon sold by Exxon Corporation of Houston, Tex.—“ISOPAR” is a Registered Trade Mark) and Halogenated hydrocarbon oil 1.8 (available commercially from Halogenated Hydrocarbon Products Corporation, River Edge, N.J., and referred to hereinafter for simplicity as “Halocarbon”) display coefficients of thermal expansion which are much greater than would be expected from the coefficients of the components, and indeed greater than that of Isopar G alone, which has a coefficient substantially exceeding that of Halocarbon.

It has also been found that the coefficients of thermal expansion of hydrocarbon/halocarbon mixtures which are substantially greater than would be predicted for ideal mixtures can be reduced, and the non-ideality of the mixtures also reduced, by blending with the mixtures a compatibilizer which has affinity for both components of the mixture. The preferred compatibilizers are fluorocarbons, a specific preferred compatibilizer being fluorotoluene. The fluorotoluene is preferably present in the mixture in an amount of at least about 5 percent, and desirably at least about 8 percent, by weight; adding more than about 10 percent fluorotoluene does not appear to give any additional advantage, and is thus best avoided for reasons of cost.

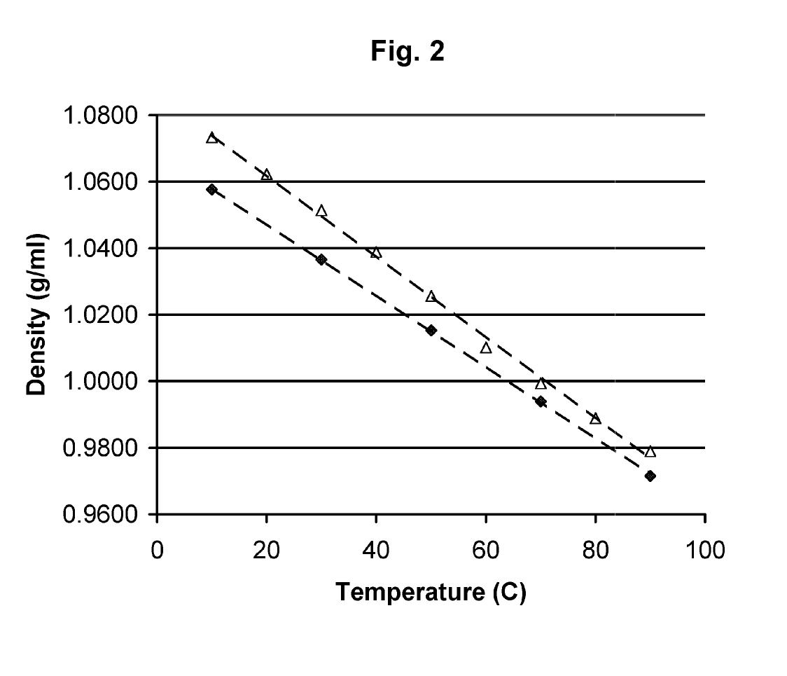

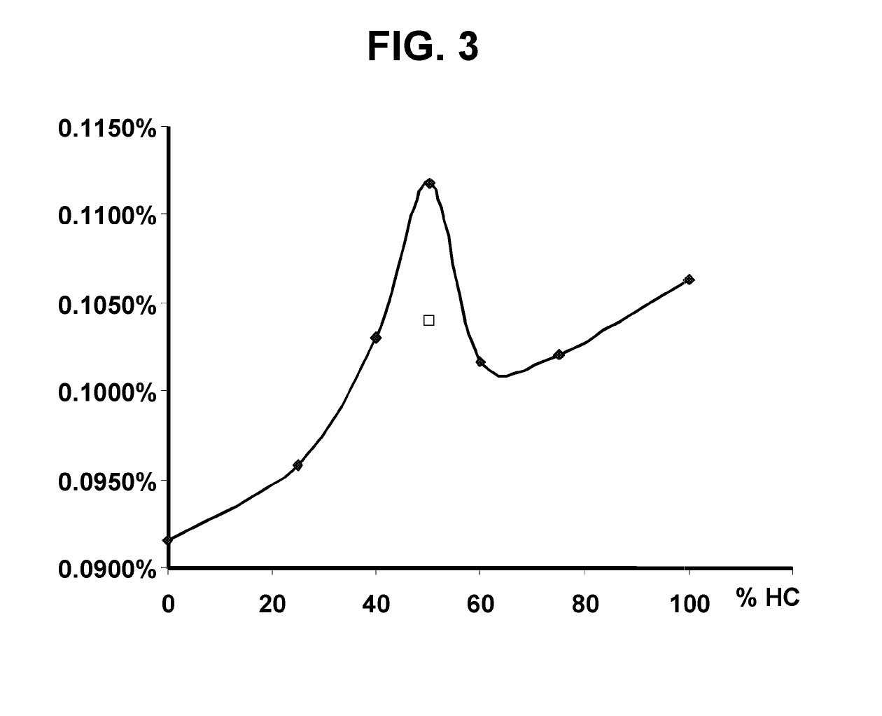

The reduction in expansion of hydrocarbon/halocarbon mixtures achieved with fluorotoluene is illustrated in FIGS. 2 and 3 of the accompanying drawings. FIG. 2 is a graph showing the variation in density with temperature for a 1:1 w/w Isopar G/Halocarbon mixture (upper line, marked with triangles) and for a 45:45:10 w/w Isopar G/Halocarbon/fluorotoluene mixture (lower line, marked with diamonds). The marked best fit lines are (where y is the density and x is the temperature in ° C.), for the binary mixture:
y=−0.0012x+1.0863
and for the ternary mixture:
y=−0.0011x+1.0688.

FIG. 3 plots the average percent change in density per degree Centigrade, over the same 10-90° C. range as in FIG. 2, for Isopar G/Halocarbon mixtures against the weight percentage of Isopar in the mixture. From this Figure, it will be seen that over the ranges of 0-25 percent and 75-100 percent Isopar, the mixtures exhibit essentially ideal behavior, with the density decrease of the mixtures being equal to the weighted average of the density decrease of the individual components (i.e., the points fall on a straight line linking between the points representing the pure components). However, within the range of 25-75 percent Isopar, the mixtures exhibit substantial non-ideal behavior, with the density decrease being substantially greater than the weighted average of the values for the individual components; the deviation from ideal behavior appears to be greatest at about 50 percent Isopar.

The isolated point in FIG. 3 is the density decrease for the aforementioned 45:45:10 w/w Isopar G/Halocarbon/fluorotoluene mixture. It will be seen that the deviation from ideal behavior for this ternary mixture is far less (by a factor of about two thirds) than for the 50:50 Isopar G/Halocarbon mixture. Thus, addition of the fluorocarbon as a compatibilizer greater reduces the problems caused by non-ideal behavior of the hydrocarbon/halocarbon mixture, and thus reduces the problems in electrophoretic media caused by the anomalously large coefficients of thermal expansion of some hydrocarbon/halocarbon mixtures.

The compatibilizer-containing electrophoretic medium of the present invention may be of any known encapsulated or microcell type. Apart from the provision of the compatibilizer in accordance with the present invention, the preferred materials and structures for the electrophoretic medium are unchanged, and for further details the reader is referred to the various patents and applications mentioned above.

Those skilled in the part of electro-optic displays will appreciate that numerous changes, improvements and modifications can be made in the preferred embodiments of the invention already described without departing from the scope of the invention. Accordingly, the whole of the foregoing description is intended to be construed in an illustrative and not in a limitative sense.

1. An electrophoretic medium comprising a suspending fluid and a plurality of electrically charged particles suspended in the suspending fluid and capable of moving therethrough upon application of an electrical field to the electrophoretic medium, the suspending fluid containing a compatibilizer to reduce its coefficient of thermal expansion.

2. An electrophoretic medium according to claim 1 wherein the suspending fluid comprises a mixture of an aliphatic hydrocarbon and a chlorinated hydrocarbon.

3. An electrophoretic medium according to claim 1 wherein the compatibilizer comprises a fluorocarbon.

4. An electrophoretic medium according to claim 3 wherein the compatibilizer comprises fluorotoluene.

5. An electrophoretic medium according to claim 4 wherein the fluorotoluene is present in an amount of at least about 5 percent by weight of the suspending fluid.

6. An electrophoretic medium according to claim 5 wherein the fluorotoluene is present in an amount of at least about 8 percent by weight of the suspending fluid.

7. An electrophoretic medium according to claim 6 wherein the fluorotoluene is present in an amount not greater than about 10 percent by weight of the suspending fluid.

8. An electrophoretic medium according to claim 1 comprising at least one capsule having a capsule wall encapsulating the suspending fluid and the electrically charged particles.

9. An electrophoretic medium according to claim 1 comprising a substrate having a plurality of closed cells formed therein, each of the cells having therein the suspending fluid and the electrically charged particles.

10. An electrophoretic medium according to claim 1 comprising a plurality of discrete droplets of an electrophoretic fluid and a continuous phase of a polymeric material.

11. A process for producing an electrophoretic display, the process comprising:
providing a sub-assembly comprising, a substrate and a layer of an electrophoretic medium adhered to the substrate;
providing a layer of lamination adhesive;
providing a backplane comprising a plurality of electrodes; and
laminating the sub-assembly, layer of lamination adhesive and backplane together with the layer of lamination adhesive disposed between the electrophoretic medium and the backplane, thereby forming the electrophoretic display,
wherein the electrophoretic medium comprising a suspending fluid and a plurality of electrically charged particles suspended in the suspending fluid and capable of moving therethrough upon application of an electrical field to the electrophoretic medium, the suspending fluid containing a compatibilizer to reduce its coefficient of thermal expansion.

12. A process according to claim 11 wherein the suspending fluid comprises a mixture of an aliphatic hydrocarbon and a chlorinated hydrocarbon.

13. A process according to claim 11 wherein the compatibilizer comprises a fluorocarbon.

14. A process according to claim 13 wherein the compatibilizer comprises fluorotoluene.

15. A process according to claim 14 wherein the fluorotoluene is present in an amount of at least about 5 percent by weight of the suspending fluid.

16. A process according to claim 15 wherein the fluorotoluene is present in an amount of at least about 8 percent by weight of the suspending fluid.

17. A process according to claim 16 wherein the fluorotoluene is present in an amount not greater than about 10 percent by weight of the suspending fluid.

18. A process according to claim 11 wherein the electrophoretic medium comprises at least one capsule having a capsule wall encapsulating the suspending fluid and the electrically charged particles.

19. A process according to claim 11 wherein the electrophoretic medium comprises a substrate having a plurality of closed cells formed therein, each of the cells having therein the suspending fluid and the electrically charged particles.

20. A process according to claim 11 wherein the electrophoretic medium comprises a plurality of discrete droplets of an electrophoretic fluid and a continuous phase of a polymeric material.
